(19) United States
(12) Patent Application Publication
(10) Pub. No.: US 2016/0258403 A1
(43) Pub. Date: Sep. 8, 2016

(54) VALVE ASSEMBLY FOR A PRIMING PUMP

(71) Applicant: Caterpillar Inc., Peoria, IL (US)

(72) Inventor: Andrew Ogden Marrack, Peoria, IL (US)

(73) Assignee: Caterpillar Inc., Peoria, IL (US)

(21) Appl. No.: 15/157,731

(22) Filed: May 18, 2016

(51) Int. Cl. F02M 59/46; F16K 1/00; F16K 31/04; F16K 31/16; F02M 59/44; F16K 31/44

(52) U.S. Cl. CPC F02M 59/46; F02M 59/447; F16K 31/44; F16K 31/047; F16K 31/16; F16K 1/00

(57) ABSTRACT

A valve assembly for a pump driven by a motor is provided. The motor has an output shaft for driving the pump. The valve assembly includes a valve element concentrically attached to the output shaft of the motor. The valve assembly includes a gear set mounted on the output shaft of the motor. The gear set provides a motive force to the valve element through the output shaft for axially translating between an open position and a closed position on the output shaft. A spring located between the gear set and the valve element biases the valve element against the motive force provided by the gear set.

### TECHNICAL FIELD

The present disclosure relates to a fuel priming pump. More specifically, the present disclosure relates to a valve assembly for a fuel priming pump.

### BACKGROUND

Fuel pumps are used to supply fuel to a fuel rail or an injector in an internal combustion engine. Fuel pumps are driven by deriving a portion of power produced by the engine. While starting an engine, the engine may not be able to provide the required adequate power to run the fuel pump. A fuel priming pump is used to pump the fuel from a fuel supply source to the fuel rail or the injector at the time of starting the engine.

Priming pumps have long been used as auxiliary devices to promote starting of engines. A priming pump may be placed in a bypass fuel line between the fuel supply source and the engine in series/parallel with the main fuel pump. The purpose of the priming pump is to pump sufficient fuel from the fuel supply source (e.g. a fuel tank) to the engine and particularly to the fuel rail/injectors of an engine to enable the engine to be cold-started without supplying excessive power to the fuel pump. The priming pump may also be used to remove air from a fuel system after the fuel system has undergone a maintenance activity such as a fuel filter change etc. After the main fuel pump is primed, the operation of the priming pump is no longer necessary. The priming pump includes a bypass passage to allow the fuel to bypass across the priming pump. The bypass passage may include a check valve. The check valve may be spring loaded or biased by any other suitable mechanism. The check valves are generally lightly loaded. This may cause restrictions in the bypass passage and may cause problems in adequate supply of the fuel to the fuel rail/injector. The problems may include, for example, reduction in fuel filter life, cavitation in the fuel system, air bubble formation and low efficiency of the fuel pump.

U.S. Pat. No. 3,617,154 discloses an oil burner system comprising a motor-driven pump which controls a burner nozzle bypass valve. The oil burner is supplied fuel oil by a fuel oil pump and a blower provides air for combustion of the oil. A single, common motor drives the oil pump and the air blower independently of each other. An oil pump motor shaft actuates a valve element opening and closing a bypass valve, in a bypass line, allowing oil to pass from the discharge or pressure side of the pump to the suction side when the pump motor is de-energized and closing the valve when energized.

An improved valve assembly is required to provide a low restriction bypass passage across the priming pump.

### SUMMARY OF THE DISCLOSURE

In an aspect of the present disclosure, a valve assembly for a pump driven by a motor is provided. The motor has an output shaft to drive the pump. The valve assembly includes a valve element concentrically attached to the output shaft of the motor. The valve assembly includes a gear set mounted on the output shaft of the motor. The gear set provides a motive force to the valve element through the output shaft to axially translate between an open position and a closed position on the output shaft. A spring is located between the gear set and the valve element. The spring biases the valve element against the motive force provided by the gear set.

### BRIEF DESCRIPTION OF DRAWINGS

FIG. 1 shows a pump assembly driven by a motor while the motor is in an OFF position, in accordance with an embodiment of the present disclosure; and

FIG. 2 shows the pump assembly shown in FIG. 1 while the motor is in an ON position, in accordance with an embodiment of the present disclosure.

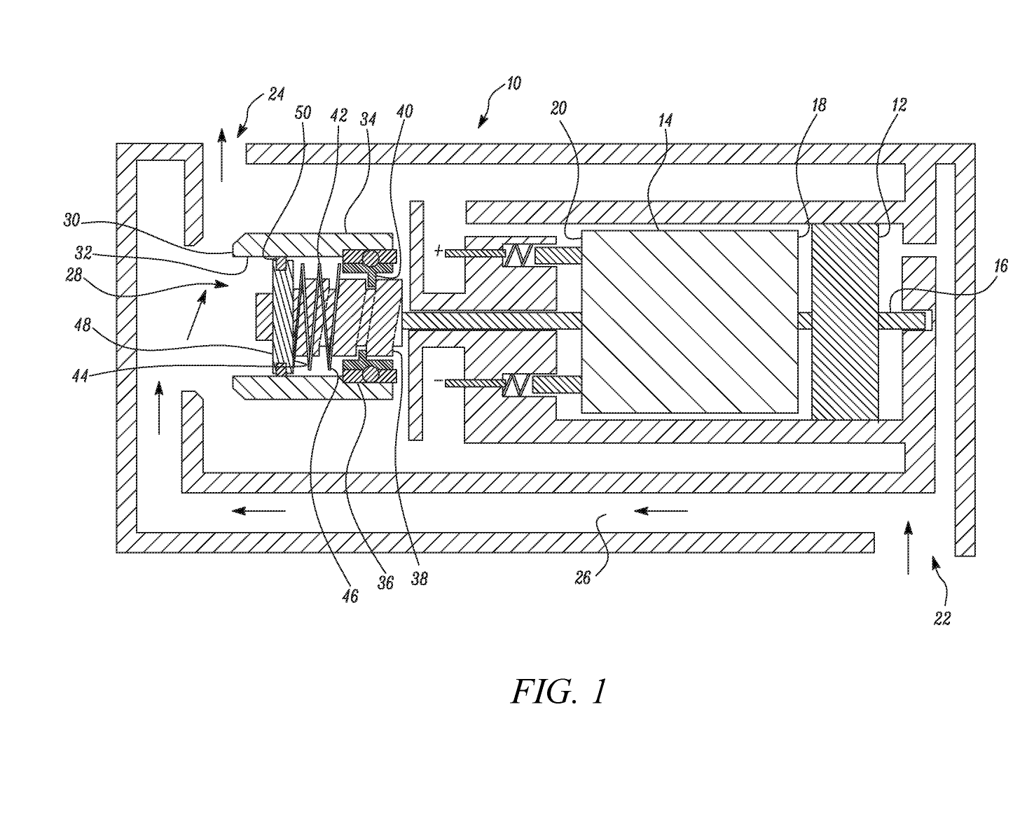

### DETAILED DESCRIPTION

Wherever possible, the same reference numbers will be used throughout the drawings to refer to same or like parts. FIG. 1 illustrates a pump assembly 10. In an embodiment, the pump assembly 10 may be used to supply pressurized fuel to an internal combustion engine while a main fuel pump of the internal combustion engine is being primed (not shown). The pump assembly 10 may he used for any other application as well without limiting the scope of present disclosure.

The pump assembly 10 includes a pump 12. The pump 12 may be used to pressurize fuel as per the required application. The pump 12 is actuated by a motor 14. The motor 14 may be an electric motor or a pneumatic motor. The motor 14 may be any other type of motor as well within the scope of the present disclosure. The motor 14 has an OFF configuration and an ON configuration. FIG. 1 illustrates the motor 14 in the OFF configuration. In the OFF configuration, the motor 14 is not supplied with any power. The motor 14 includes an output shaft 16. The output shaft 16 provides the pump 12 with the power required for operation of the pump 12. The motor 14 has a first end 18 adjacent to the pump 12 and a second end 20 opposite to the first end 18 of the motor 14. The output shaft 16 connects the motor 14 to the pump 12 adjacent to the first end 18. The output shaft 16 may be connected with the pump 12 through a gear mechanism etc. (not shown). The output shaft 16 extends towards the second end 20 as well.

The pump assembly 10 includes an inlet port 22 and an outlet port 24. The inlet port 22 may be coupled with a fuel source such as a fuel tank etc. (not shown). The fuel source supplies fuel through the inlet port 22. The fuel coining from the inlet port 22 flows through the pump assembly 10 depending on whether the motor 14 is operating in the OFF configuration or the ON configuration. While the motor 14 is operating in the OFF configuration, the fuel passes through a bypass passage 26 to the outlet port 24. The outlet port 24 may be coupled with a fuel rail or an injector for supplying the pressurized fuel to the engine (not shown). In an embodiment, the outlet port 24 may be coupled with the main fuel pump.

The bypass passage 26 connects the inlet port 22 and the outlet port 24 bypassing the pump 12. The bypass passage 26 includes a valve assembly 28. The valve assembly 28 is located near the outlet port 24. The valve assembly 28 controls opening and closing of the bypass passage 26. The valve assembly 28 includes a valve element 30. The valve element 30 may be any type of a valve suitable to application in the present disclosure. The valve element 30 may be a poppet valve, a butterfly valve, a spool valve and the like. The valve element 30 is concentrically attached to the output shaft 16 of the motor 14 adjacent to the second end 20 of the motor 14. The valve element 30 has an inner face 32 and an outer face 34. The valve element 30 can be axially translated on the output shaft 16 between an open position and a closed position.

The valve assembly 28 is illustrated in the open position in FIG. 1. The open position of the valve element 30 corresponds to the OFF position of the motor 14. The valve assembly 28, while in the open position, allows the fuel to pass through the bypass passage 26. The valve assembly 28 further includes a bearing 36 to prevent the valve element 30 from translating past the open position and the closed position. The bearing 36 is concentrically attached to the output shaft 16 between the inner face 32 of the valve element 30 and the outer face 34 of the valve element 30.

The valve assembly 28 further includes a gear set 38. The gear set 38 is mounted on the output shaft 16. The gear set 38 provides the valve element 30 with the required power to axially translate between the open position and the closed position through the output shaft 16. The gear set 38 converts the rotary motion of the output shaft 16 to the translation motion of the valve element 30 on the output shaft 16. The valve element 30 includes an extended portion 40 on the inner face 32 to engage the gear set 38. The gear set 38 may be a worm gear, a helical gear or any other gear able to provide such functionality. The gear set 38 is coupled with the output shaft 16 towards the second end 20 of the motor 14. The gear set 38 may be coupled to the output shaft 16 through a mechanical connection such as fasteners etc. The gear set 38 may also be coupled to the output shaft 16 by welding, brazing or any other process suitable for application to the present disclosure.

With continued reference to FIG. 1, the valve assembly 28 includes a spring 42. The spring 42 is located between the gear set 38 and the valve element 30. The spring 42 biases the valve element 30 against the force provided by the gear set 38 for axial translation on the output shaft 16. The spring 42 may be a coil spring, a helical spring or any other type of spring which may suit the current application. The spring 42 remains in either a compressed state or a relaxed state. The spring 42 is illustrated as being in the relaxed state in FIG. 1. The relaxed state of the spring 42 corresponds to the open position of the valve element 30.

The spring 42 has a first end 44 and a second end 46. The first end 44 is attached to a spring mount 48. The spring mount 48 is attached to the output shaft 16 at an end of the output shaft 16 towards the second end 20 of the motor 14. The spring mount 48 remains in a fixed position as illustrated in the FIG. 1. The second end 46 of the spring 42 is in contact with the extended portion 40. The spring 42 applies a force on the valve element 30. The force applied by the spring 42 depends on a force constant of the spring 42. The force constant is a characteristic property of the spring 42. An appropriate spring may he selected based on the force constant as per the required application.

The spring mount 48 may have a seal 50 located around the spring mount 48. The seal 50 prevents fuel from flowing past the spring mount 48. It may be possible that a small amount of fuel may leak from the pump 12 by flowing along the output shaft 16 and the gear set 38. The leaked fuel may further flow back to the inlet port 22 from radial space between the spring mount 48 and the valve element 30. The leaked fuel may cause problems in efficient functioning of the pump assembly 10 as the leaked fuel would be at a higher pressure compared to the fuel coming in from the inlet port 22. The seal 50 helps avoid any such circumstances and ensures a safe operation of the pump assembly 10. The seal 10 may be a face seal, a tapered seal, a threaded cap or any other type of seal suitable for the required application.

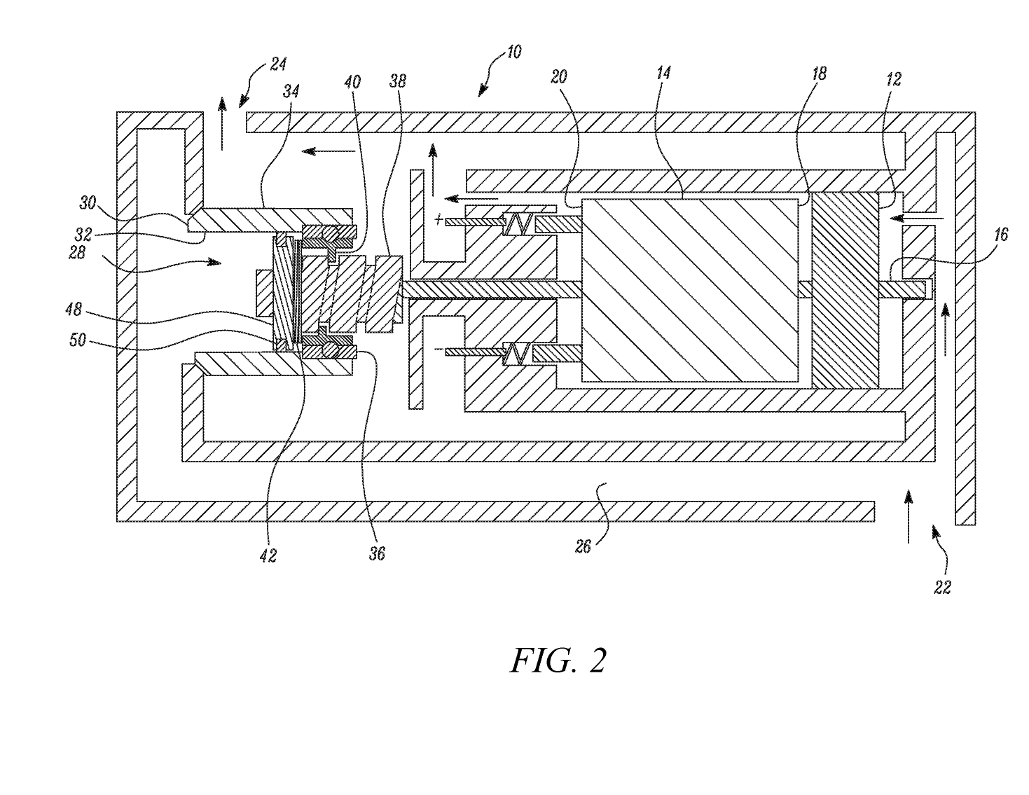

FIG. 2 shows the pump assembly 10 with the motor 14 in the ON configuration. In the ON configuration, the motor 14 is supplied with required power to drive the pump 12. The motor 14 rotates the output shaft 16 to drive the pump 12. The output shaft 16 rotates the gear set 38 and axially translates the valve element 30 to the closed position so as to compress the spring 42 against the spring mount 48. The bypass passage 26 gets closed by the valve assembly 28. The fuel coming in from the inlet port 22 flows to the pump 12. The pump 12 pressurizes the fuel and supplies the fuel to the outlet port 24. The outlet port 24 may be coupled with a fuel rail or an injector for supplying the pressurized fuel to the engine.

As illustrated in FIGS. 1 and 2, ON and OFF configurations of the motor 14 correspond to the closed and open positions of the valve element 30 respectively. However, it may be contemplated that as per the required application, an inverse arrangement is also possible in which ON and OFF configurations of the motor 14 may correspond to the open and closed positions of the valve element 30 respectively. One of the ways to achieve inverse configuration is to change the orientation of the gear set 38. Other ways and relative arrangement of various parts of the valve assembly 28 may also be possible to attain the inverse arrangement.

### INDUSTRIAL APPLICABILITY

Priming pumps are used to supply fuel to an internal combustion engine while the engine is being started and is unable to provide power to main fuel pump. The priming pump may also be used to purge air out of the fuel system after maintenance/servicing. The priming pump may be supplied power through a motor driven by a power source other than the engine. However, once the main fuel pump is primed, the priming pump is no longer in operation. Priming pumps are provided with a bypass passage for the fuel to pass through when the priming pump is not in operation. The bypass passage may have a valve arrangement to open or close the bypass passage. Generally, spring loaded check valves are provided in the bypass passage to open or close the bypass passage which may cause restrictions to fuel flow and may cause problems in adequate supply of fuel to the engine such as reduced fuel filter life, cavitation, air bubble formation, low fuel pump efficiency etc.

The present disclosure provides low restriction bypass passage 26 around the pump assembly 10. The bypass passage 26 includes the valve assembly 28. The valve assembly 28 controls the opening and closing of the bypass passage 26. While the motor 14 of the pump assembly 10 is in ON configuration, the output shaft 16 of the motor 14 rotates and provides power to the pump 12 to pressurize the fuel. The pressurized fuel is supplied to the engine through the outlet port 24, The bypass passage 26 is required to be kept closed in this configuration. The output shaft 16 provides power to the valve element 30 through the gear set 38 to overcome the force applied by the spring 42 holding the valve element 30 in the open position. The valve element 30 is held in the closed position and the bypass passage 26 is closed.

When the motor 14 is in OFF configuration, the output shaft 16 stops rotating. The spring force holds the valve element 30 in the open position. Thus, the bypass passage 26 is kept open. The fuel enters through the inlet port 22 and flows through the bypass passage 26 and finally exits through the outlet port 24. The improved valve assembly 28 allows for little or no restrictions to the flow of fuel through the bypass passage 26. As, the valve assembly 28 is actuated based upon the motor 14 being in an ON/OFF configuration, the bypass passage 26 is open/closed accordingly as required.

Although the present disclosure is explained via example of a priming pump, the valve assembly 28 of the present disclosure may also be applied in any other pump as well. Any fluid may be used in place of fuel for operating the pump 12. The scope of the present disclosure in any way is not limited to a priming pump environment or a specific fluid type.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A valve assembly for a pump driven by a motor, the motor having an output shall to drive the pump, the valve assembly comprising:
a valve element concentrically attached to the output shaft of the motor;
a gear set mounted on the output shaft of the motor, wherein the gear set provides a motive force to the valve element, through the output shaft, to axially translate between an open position and a closed position on the output shaft; and
a spring disposed between the gear set and the valve element, wherein the spring biases the valve element against the motive force provided by the gear set.

2. The valve assembly of claim 1, wherein the gear set is a helical gear set or a worm gear set.

3. The valve assembly of claim 1 further includes a bearing element adapted to restrict the valve element to axially translate past the closed position and the open position.
